(19) United States
(12) Patent Application Publication
(10) Pub. No.: US 2009/0193240 A1
(43) Pub. Date: Jul. 30, 2009

(54) METHOD AND APPARATUS FOR INCREASING THREAD PRIORITY IN RESPONSE TO FLUSH INFORMATION IN A MULTI-THREADED PROCESSOR OF AN INFORMATION HANDLING SYSTEM

(75) Inventors: Michael Karl Gschwind, Chappaqua, NY (US); Robert Alan Philhower, Valley Cottage, NY (US); Raymond Cheung Yeung, Round Rock, TX (US)

Correspondence Address: MARK P. KAHLER, 8101 VAILVIEW COVE, AUSTIN, TX, 78750, US

(73) Assignee: IBM Corporation, Austin, TX (US)

(21) Appl. No.: 12/023,028

(22) Filed: Jan. 30, 2008

(51) Int. Cl. G06F 9/30

(52) U.S. Cl. 712/239; 712/E09.016

(57) ABSTRACT

An information handling system employs a processor that includes a thread priority controller. The processor includes a memory array that stores instruction threads including branch instructions. A branch unit in the processor sends flush information to the thread priority controller when a particular branch instruction in a particular instruction thread requires a flush operation. The flush information may indicate the correctness of incorrectness of a branch prediction for the particular branch instruction and thus the necessity of a flush operation. The flush information may also include a thread ID of the particular thread. If the flush information for the particular branch instruction of the particular thread indicates that a flush operation is necessary, the thread priority controller in response speculatively increases or boosts the priority of the particular instruction thread including the particular branch instruction. In this manner, a fetcher in the processor obtains ready access to the particular thread in the memory array.

### TECHNICAL FIELD OF THE INVENTION

The disclosures herein relate generally to processors, and more particularly, to multi-threading processors in information handling systems.

### BACKGROUND

Early processors included a single core that employed relatively low clock speeds to process an instruction stream. More recent processors still employed a single core to process a single instruction stream, but increased performance by employing techniques such as branch prediction, out-of-order execution as well as first and second level on-chip memory caching. Processors with increased clock speed experienced improved performance, but encountered undesirable power dissipation problems that ultimately limited clock speed. Moreover, increased clock speed may actually result in lower execution unit utilization because of increases in the number of clock cycles required for instruction execution, branch misprediction, cache misses and memory access.

Multi-threading provides a way to increase execution unit utilization by providing thread-level parallelism that improves the throughput of the processor. A thread is an instruction sequence that can execute independently of other threads. One thread may share data with other threads. Multi-threading processors typically include a thread priority circuit that determines which particular thread of multiple threads the processor should process at any particular point in time. Multi-core processors may use multi-threading to increase performance.

What is needed is an apparatus and methodology that improves thread selection in a multi-threaded processor of an information handling system.

### SUMMARY

Accordingly, in one embodiment, a method is disclosed for operating a multi-threaded processor. The method includes storing, by a memory array, a plurality of instruction threads. The method also includes fetching, by a fetcher, a particular instruction thread from the memory array, the particular instruction thread including a particular branch instruction, the fetcher communicating with a thread priority controller. The method further includes predicting, by a branch predictor, an outcome of the particular branch instruction of the particular instruction thread, thus providing a branch prediction. The method still further includes issuing, by an issue unit, the particular branch instruction of the particular instruction thread to a branch execution unit. The method also includes speculatively executing, by the branch execution unit, the particular branch instruction of the particular instruction thread in response to the branch prediction. The method further includes sending, by the branch execution unit, flush information to the thread priority controller, the flush information indicating the correctness or incorrectness of the branch prediction for the particular branch instruction of the particular thread. The method also includes modifying, by the thread priority controller, a priority of the particular instruction thread in response to the flush information indicating that the particular branch instruction was incorrectly predicted.

In another embodiment, a processor is disclosed that includes a memory array that stores instruction threads that include branch instructions. The processor also includes a fetcher, coupled to the memory array, that fetches a particular instruction thread including a particular branch instruction from the memory array. The processor further includes a branch predictor, coupled to the fetcher, that predicts an outcome of the particular branch instruction, thus providing a branch prediction for the particular branch instruction. The processor still further includes a branch execution unit, coupled to the branch predictor, that executes branch instructions and provides flush information related to the branch instructions that it executes. The processor includes an issue unit, coupled to the memory array and the branch execution unit, that issues the particular branch instruction of the particular thread to the branch execution unit for execution. The processor also includes a thread priority controller, coupled to branch execution unit and the memory array, to receive the flush information from the branch execution unit, wherein the thread priority controller modifies a priority of the particular instruction thread in response to the flush information indicating that the particular branch instruction of the particular instruction thread was incorrectly predicted.

### BRIEF DESCRIPTION OF THE DRAWINGS

The appended drawings illustrate only exemplary embodiments of the invention and therefore do not limit its scope because the inventive concepts lend themselves to other equally effective embodiments.

FIG. 1 shows a block diagram of a conventional multi-thread processor that employs a thread priority controller.

FIG. 2 shows a typical multi-thread timeline for the conventional multi-thread processor of FIG. 1.

FIG. 3 shows a block diagram of the disclosed processor including a thread priority controller that receives flush information.

FIG. 4 is a representative timeline for the disclosed processor of FIG. 3.

FIG. 5 is a flowchart that depicts one embodiment of the methodology that the processor of FIG. 3 employs.

FIG. 6 is block diagram of an information handling system (IHS) that employs the processor of FIG. 3 and the methodology of FIG. 5.

### DETAILED DESCRIPTION

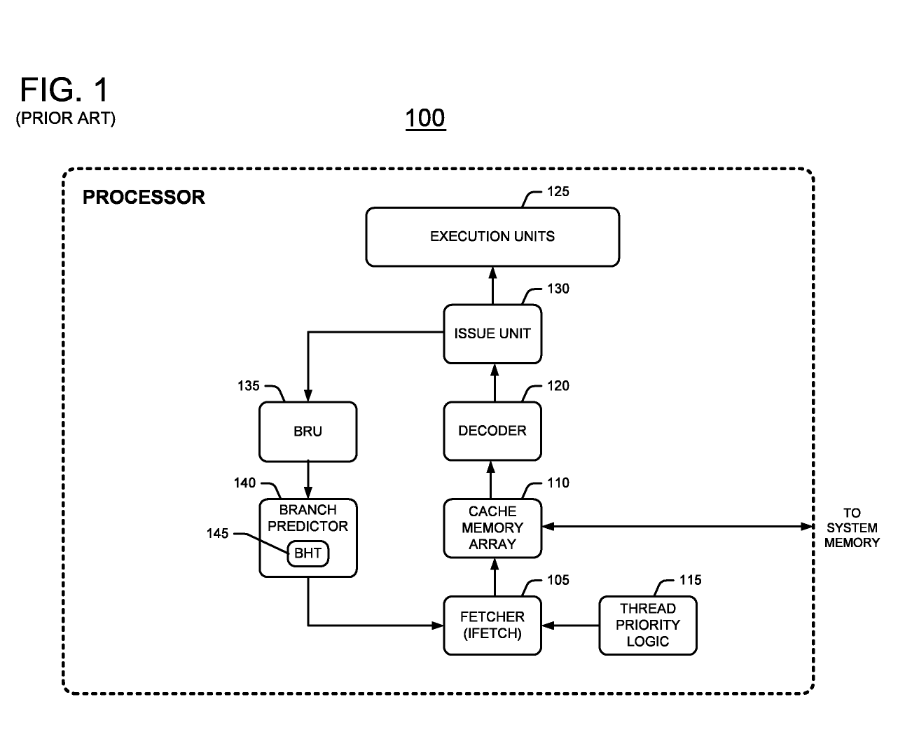

FIG. 1 shows a conventional multi-threaded processor 100 including a fetcher 105 that fetches instructions from an instruction source such as a cache memory array 110. A thread priority logic circuit 115 couples to fetcher 105 to instruct fetcher 105 which particular thread to fetch from cache memory array 110. Memory array 110 couples to a system memory (not shown) that is external to processor 100. A decoder 120 receives groups of fetched instructions corresponding to threads from the instruction stream that fetcher 105 and memory array 110 provide. This instruction stream includes instruction threads that execution units 125 will execute. Decoder 120 decodes the fetched instructions and provides decoded instructions corresponding to the threads to issue unit 130 for issue to execution units. Issue unit 130 issues the instructions of the threads to appropriate execution units 125 for execution.

Processor 100 uses speculative execution methodology with branch prediction to increase the instruction handling efficiency of the processor. Fetcher 105 fetches a stream of instructions that contains branch instructions. Processor 100 may speculatively execute instructions after a branch instruction in response to a branch prediction. Speculatively executing instructions after a branch typically involves accessing cache memory array 110 to obtain the instructions following the branch. In more detail, after decoder 120 decodes a fetched branch instruction of the instruction stream, a branch prediction circuit 140 makes a prediction whether or not to take the branch that the branch instruction offers. The branch is either “taken” or “not taken”. Branch prediction circuit 140 predicts whether or not to take the branch by using branch history information, namely the branch results when the processor encountered this particular branch instruction in the past. Branch history table (BHT) 145 stores this branch history information. If branch prediction circuit 140 predicts the branch correctly, then processor 100 keeps the results of the speculatively executed instructions after the branch. However, if the branch prediction is incorrect, then processor 100 discards or flushes the results of instructions after the branch. Processor 100 then starts executing instructions at a redirect address that corresponds to the correct target address of the branch instruction after branch resolution.

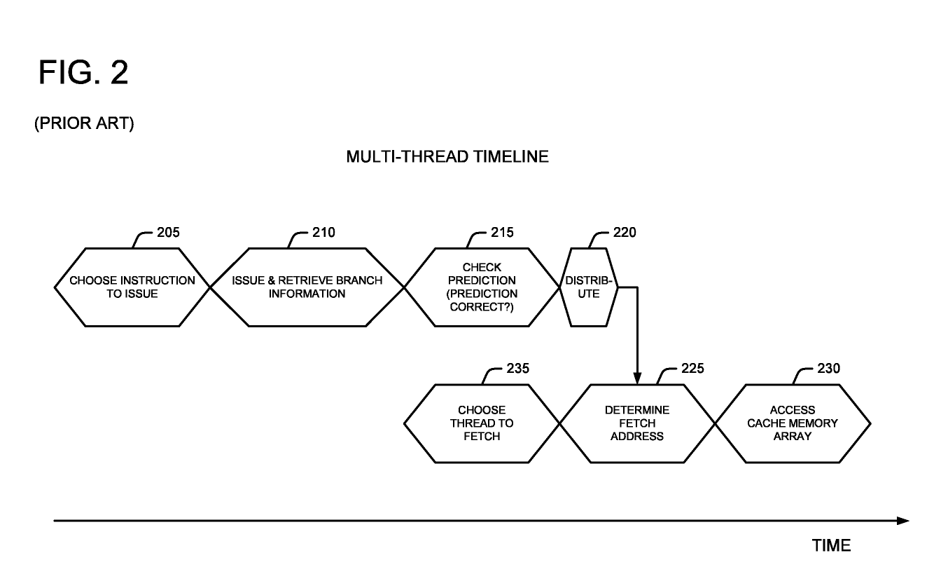

FIG. 2 shows a typical multi-threaded timeline for the conventional multi-threaded processor 100 of FIG. 1. Issue unit 130 in the multi-threaded processor 100 selects an instruction to issue during time block 205. Issue unit 130 issues the selected instruction and retrieves branch information during time block 210. If the issued instruction is a branch instruction, then branch unit (BRU) 135 checks branch prediction information to see if the prediction was correct during time block 215. If the branch instruction is a mispredicted branch, then branch unit 135 distributes notice of the branch misprediction to fetcher 105 during distribute time block 220. Distribute time block 220 reflects the wire delay in BRU 135 notifying fetcher 105 about a branch misprediction. During time block 225, fetcher 105 determines the next address to fetch, namely a redirect address. This fetch address may correspond to the redirect address if thread priority logic 115 selects the thread corresponding to the branch misprediction. However, if thread priority logic 115 does not select the thread corresponding to the branch misprediction, then processor 100 stores the redirect address in a register for later processing, possibly after a substantial delay. Fetcher 105 then accesses memory array 110 at the determined fetch address during time block 230. In the conventional multi-thread timeline of FIG. 2, thread priority logic 115 actually chooses the next thread to fetch during time block 235 which coincides with check branch prediction time block 215. Thus unfortunately, in the event that a branch misprediction occurs, the branch misprediction information from distribute time block 220 arrives at fetcher 105 during determine fetch address time block 225. This time is too late to affect the thread fetch decision that already occurred during “choose thread to fetch” time block 235. Thus, it is frequently possible for the branch redirect address arriving during time block 225 to be unable to affect the fetch and fetch instructions from the redirect address. When a flush occurs, the flush may cause significant impact on the achievable performance of the processor when executing instructions from the thread causing the flush. This impact occurs because the flush removes a large number of instructions from an issue queue in the processor, thus reducing the potential for the use of parallelism with respect to the thread subject to the flush. This potentially causes significant performance degradation for the corresponding thread and overall reduced aggregate utilization of processor 100.

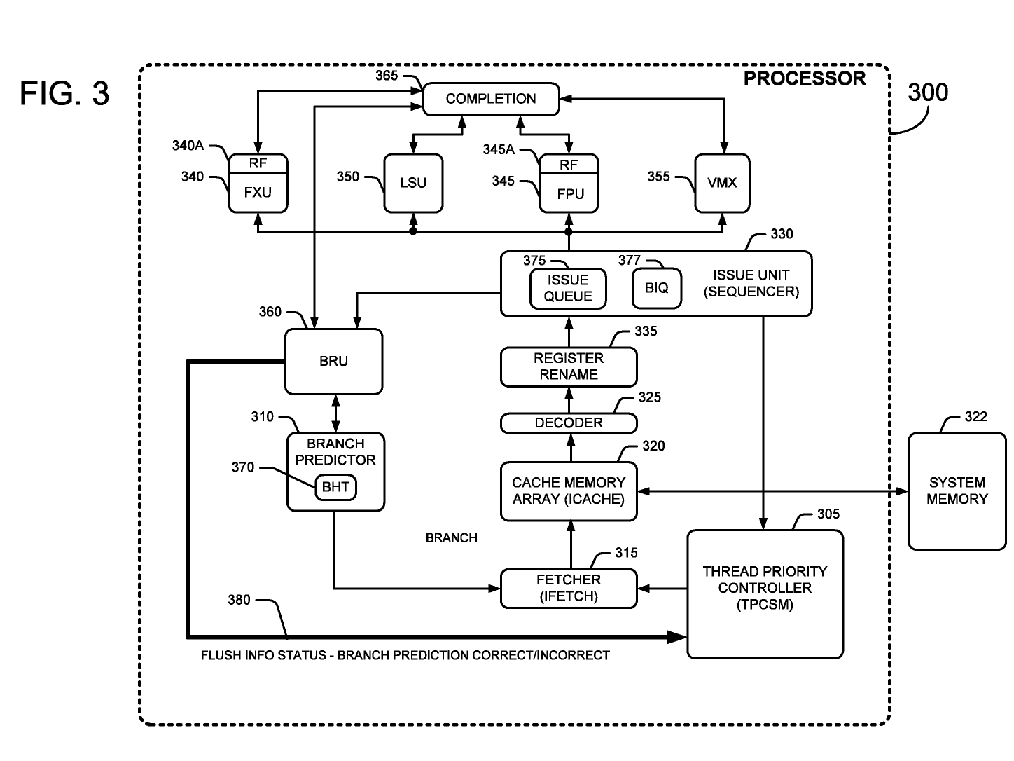

FIG. 3 is a block diagram of the disclosed multi-threaded processor 300, one embodiment of which includes a thread priority controller such as thread priority controller state machine (TPCSM) 305. TPCSM 305 may increase processor performance by speculatively increasing the priority of a particular thread that includes a branch instruction for which flush information from the branch execution unit (BRU) 360 indicates the need for a flush operation. For example, if the flush information from BRU 360 indicates that a branch mispredict occurred for that particular branch instruction, then TPCSM 305 will increase the priority of the thread including the particular branch instruction. In this manner, fetcher 315 exhibits an increased ability to fetch instructions for the thread including the particular branch instruction from cache memory array 320 after a branch mispredict. As a result of this response to the flush information, the fetcher 315 compensates for the loss of instructions, and in particular the loss of ready instructions, i.e., those instructions with no outstanding dependences. This response may enhance the ability of issue unit 330 to issue instructions and thereby exploit instruction level parallelism.

In one embodiment, processor 300 is a simultaneous multi-threaded (SMT) processor that includes multiple pipeline stages. For example, processor 300 includes a fetcher 315 that couples to TPCSM 305. TMCSM 305 determines the fetch priority of instruction threads that fetcher 315 fetches from cache memory array 320. Cache memory array 320 couples to an external system memory 322. Memory array 320 couples to a decoder 325 that decodes instructions in the fetched instruction threads that decoder 325 receives from memory array 320. Decoder 325 couples to an issue unit or sequencer 330 via register renaming circuit 335 to provide issue unit 330 with an instruction stream for execution. Register renaming circuit 335 effectively provides additional registers to enhance the execution of fetched instructions. Issue unit 330 sends ready decoded instructions to appropriate functional units for execution. Ready instructions are those instructions with no outstanding or unsatisfied dependencies. Processor 300 includes the following functional units: an integer or fixed point execution unit (FXU) 340, a floating-point execution unit (FPU) 345, a load/store execution unit (LSU) 350, a vector media extension execution unit (VMX) 355 and a branch execution unit (BRU) 360. FXU 340 and FPU 345 include register files (RFs) 340A and 345A, respectively, for storing computational results.

Branch execution unit (BRU) 360 couples to issue unit 330 to execute branch instructions that it receives from issue unit 330. BRU 360 couples to both branch predictor 310 and completion unit 365. The execution units FXU 340, LSU 350, FPU 345, VMX 355 and BRU 360 speculatively execute instructions in the instruction stream after a decoded branch instruction. Branch predictor 310 includes a branch history table (BHT) 370. Branch history table (BHT) 370 tracks the historical outcome of previously executed branch instructions. Branch unit (BRU) 360 checks branch predictions previously made by branch predictor 310 in response to instruction fetcher requests, and updates this historical branch execution information to reflect the outcome of branch instructions that it currently receives.

Completion unit 365 couples to each of the execution units, namely FXU 340, FPU 345, LSU 350, VMX 355 and BRU 360. More specifically, completion unit 365 couples to FXU register file 340A and FPU register file 345A. Completion unit 365 determines whether or not speculatively executed instructions should complete. If the branch predictor 310 correctly predicts a branch, then the instructions following the branch should complete. For example, if branch predictor 310 correctly predicts a branch, then a fixed point or integer instruction following that branch should complete. If the instruction following the correctly predicted branch is a fixed point instruction, then completion unit 365 controls the write back of the fixed point result of the branch to fixed point register file 340A. If the instruction following the correctly predicted branch is a floating point instruction, then completion unit 365 controls the write back of the result of that floating point instruction to floating point register file 345A. When instructions complete, they are no longer speculative. The branch execution unit (BRU) 360 operates in cooperation with completion unit 365 and BHT 370 to resolve whether or not a particular branch instruction is taken or not taken.

To facilitate the speculative execution of instructions, issue unit 330 includes an issue queue 375 that permits out-of-order execution of ready instructions. Ready instructions are those instructions for which all operands are present and that exhibit no outstanding or unsatisfied dependencies. Issue queue 375 stores instructions of threads awaiting issue by issue unit 330. In one embodiment, issue unit 330 includes a branch instruction queue (BIQ) 377 that stores branch instructions from the instruction stream of instruction threads that issue unit 330 receives.

BIQ 377 may include both valid and invalid branch instructions. The invalid branch instructions are those speculatively executed branch instructions that completion unit 365 resolved previously but which still remain in BIQ 377. The remaining valid branch instructions in BIQ 377 are those branch instructions still “in flight”, namely those speculatively executed branch instructions that completion unit 365 did not yet resolve. Processor 300 further includes a flush information status bus 380 that couples branch execution unit (BRU) 360 to thread priority controller state machine (TPCSM) 305. Flush information status line 380 communicates flush information that indicates whether or not processor 300 requires a flush operation after executing a particular branch instruction in a particular thread. In this manner, BRU 360 informs thread priority controller state machine (TPCSM) 305 with respect to the correct or incorrect prediction status of each branch instruction after branch resolution

Thread priority controller state machine (TPCSM) 305 controls the priority of each thread that fetcher 315 fetches from memory array 320. For each particular branch instruction that BRU 360 executes, BRU 360 sends flush information to TPCSM 305 via flush information status bus 380. In one embodiment, the flush information may also include the thread ID of the particular thread that includes the particular branch instruction that BRU 360 currently executes. In other words, the flush information may include 1) information that indicates whether or not processor 300 requires a flush operation after executing the particular branch instruction in the particular thread, and 2) the thread ID of the particular thread.

TPCSM 305 examines the flush information that it receives for a branch instruction of an instruction thread. If the flush information indicates the need for a flush operation due to a branch mispredict, then TPCSM 305 increases the priority of the particular thread including that branch instruction. TPCSM 305 communicates this increase in priority for the particular thread to fetcher 315. In this manner, fetcher 315 is ready to conduct a fetch operation at the redirect address for the mispredicted branch instruction of the particular thread more quickly than may otherwise occur. However, if the flush information does not indicate the need for a flush operation, then TPSCM 305 leaves the priority of the particular thread including the branch instruction unaltered from what it would normally be without consideration of the flush information.

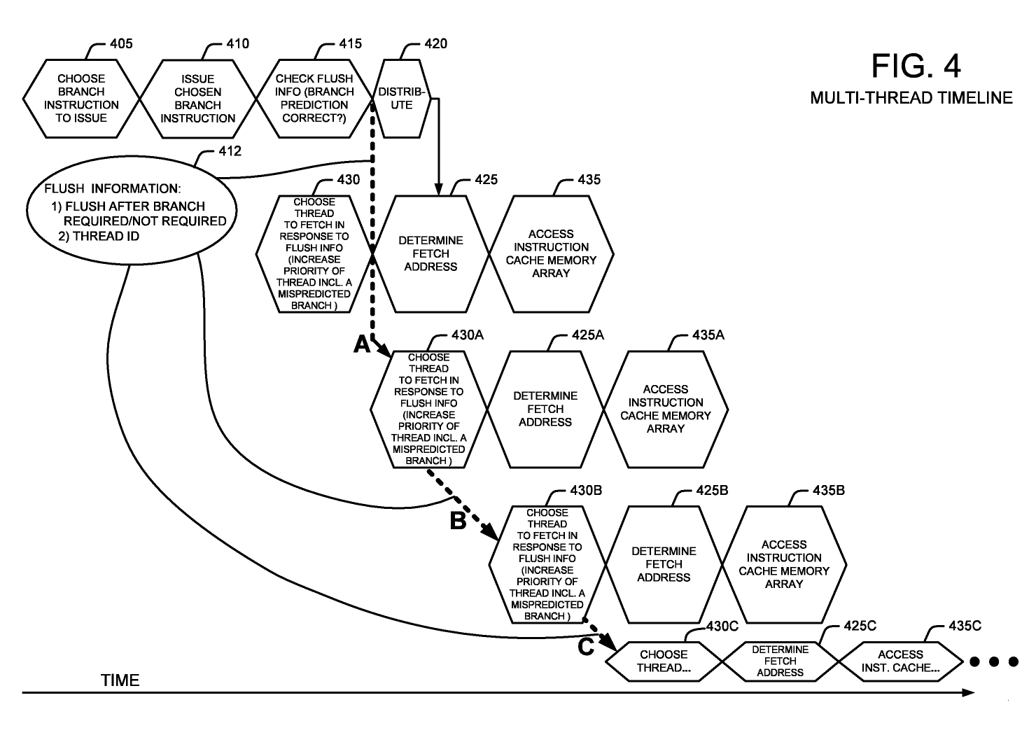

FIG. 4 shows a representative timeline for multi-threaded processor 300 of FIG. 3. Issue unit 330 selects or chooses a particular branch instruction of a thread to issue during time block 405. Issue unit 330 then issues the chosen branch instruction during time block 410. After issuing the particular branch instruction during time block 410 to BRU 360 for speculative execution, BRU 360 executes that branch instruction. During time block 415, BRU 360 checks the flush information for the particular branch instruction to determine if the branch prediction was correct. This decides whether or not a flush operation is necessary. During distribute time block 420, BRU 360 distributes flush information to fetcher 315 via flush information status bus 380. During time block 415, branch execution unit (BRU) 360 sends flush information 412 to thread priority controller state machine (TPCSM) 305. Alternatively, BRU 360 may send the flush information to TPCSM 305 during block 420. The flush information 412 may include 1) information that indicates whether or not processor 300 requires a flush operation after executing the particular branch instruction in the thread, and 2) the thread ID of the thread in which the particular branch instruction resides. TPCSM 305 uses this flush information to speculatively increase the priority of the thread including the particular branch instruction under certain circumstances. More specifically, TPCSM 305 uses this flush information to increase the fetch priority of the thread containing the particular branch instruction if the flush information for the particular branch indicates the need for a flush. For example, if the flush information indicates that the execution of the particular branch instruction resulted in a branch mispredict, then processor 300 requires a flush. In response to the flush information indicating this need for a flush operation, TPCSM 305 temporarily increases the priority of the thread including the particular branch instruction. In this manner, fetcher 315 is ready to access memory array 320 in one or more of successive memory access cycle blocks 435A, 435B, 435C and so forth, to retrieve a number of instructions associated with the thread including the particular branch instruction more quickly than may otherwise occur. This retrieval of instructions may refill the issue queue 375 with a number of ready instructions such that the issue queue may exploit instruction level parallelism by issuing a number of ready instructions.

If the flush information indicates no need for a flush operation, i.e. branch predictor 310 correctly predicted the outcome of the particular branch instruction, then fetcher 315 continues executing instructions following the particular branch instruction. To perform this task, fetcher 315 determines the fetch address of the next instruction during time block 425. After determining the fetch address, fetcher 315 accesses cache memory array 320 during time block 435. In this scenario, TPCSM 305 does not alter the priority of the thread including the particular branch instruction in response to the flush information.

However, if the flush information 412 indicates the need for a flush operation, i.e branch predictor 310 incorrectly predicted the outcome of the particular branch instruction, then a different scenario occurs. As noted above, during time block 415 or 420, branch execution unit (BRU) 330 sends flush information 412 to thread priority controller state machine (TPCSM) 305. TPCSM 305 uses this flush information to change the priority of the next thread to fetch during time block 430A. For example, TPCSM 305 checks the flush information and determines that processor 300 needs a flush operation after the particular branch instruction. In response to this flush information, TPCSM 305 increases the priority of the thread including the particular branch instruction that requires a flush operation. In this manner, TPCSM 305 determines the next thread to fetch using the flush information during time block 430 and so informs fetcher 315 of the priority of the next thread to fetch. Fetcher 315 in cooperation with TPCSM 305 determines the next fetch address during block 425A. Fetcher 315 accesses cache memory array 320 during block 435A to retrieve the next thread indicated by the next fetch address. In this scenario, TPCSM 305 altered the priority of the thread including the particular branch instruction in response to the flush information.

This method provides a way to compensate for the removal of many ready instructions from the instruction queue 375 when a flush occurs due to a particular branch in to thread requiring the flush. In this scenario, it is likely that the instruction queue 375 does not contain a large number of instructions for that thread. The method may effectively boost the ability of the thread to fetch from successive cycles as shown by blocks 430, 425, 435, and a cycle later by blocks 430A, 425A, 435A, and a cycle later 430B, 425B, 435B, and a cycle later by blocks 430C, 425C, 435C, and so forth. Each successive cycle includes a respective boost decision, i.e. at blocks 430A, 430B, 430C, and so forth.

While BRU 330 sends the flush information for the particular branch instruction to TPCSM 305 during block 415 or 420, it does not arrive at TPCSM 305 in time to increase the priority of the branch's thread in association with choose thread block 430, determine fetch address block 425 and access memory array block 435. However, the flush information for the particular branch does arrive at TPCSM 305 in time to increase the priority of the branch's thread during subsequent cycles associated with blocks 430A,425A, 435A and subsequent cycles associated with block 430B,425B, 435B and still further subsequent cycles associated with blocks 430C,425C, 435C, and so forth. In other words, in one embodiment, the flush information 412 associated with a particular branch instruction of a thread may not reach TPCSM 305 until 430A as indicated by the dashed line A in FIG. 4. In response to the flush information arriving at TPCSM 305 as indicated by dashed line A, TPCSM 305 temporarily instructs fetcher 315 to increase the priority of the thread including the particular branch instruction to which the flush information pertains. TPCSM again considers this flush information at choose thread to fetch block 430B via dashed arrow B. TPCSM 305 may still further consider the flush information 412 at choose thread to fetch block 430C, as indicated by dashed arrow C, and so forth.

Choose a thread to fetch block 430A effectively allocates cache memory array 320 to the particular thread for an amount of time. Allocate block is another term usable to refer to choose a thread to fetch block 430A. Determine the fetch address block 425A follows choosing a thread to fetch or allocate block 430A. Access memory array block 435A follows determine fetch address block 425A. During access memory array block 435, the fetcher 315 actually accesses memory array 320. These steps of allocating memory, determining the fetch address and accessing memory repeat continuously offset by one cycle, as shown in FIG. 4.

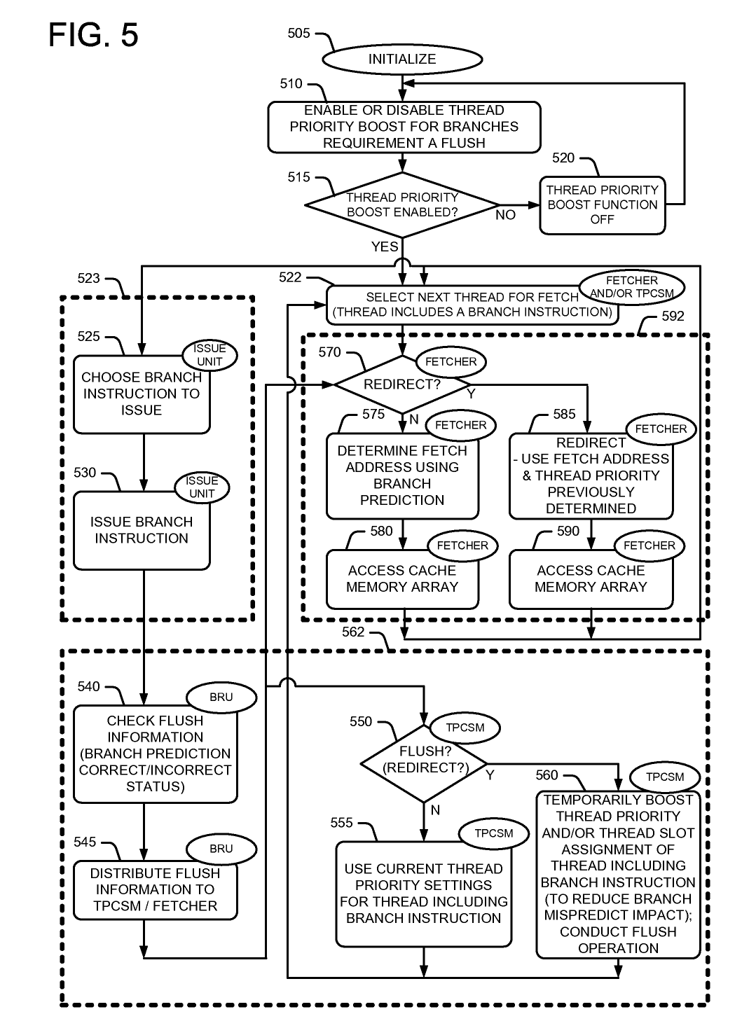

FIG. 5 is a flowchart that depicts one embodiment of the methodology that processor 300 employs to process threads including branch instructions. Process flow commences when processor 300 initializes at block 505. A user or other entity may enable or disable the boost function of TPCSM 305 that increases thread priority for a thread that requires a processor flush operation, as per block 510. TPCSM 305 checks to see if the thread priority boost function exhibits the enabled state, as per decision block 515. If the thread priority boost function does not exhibit the enabled state, then TPCSM 305 turns the thread priority boost function off, as per block 520. In this event, decision block 515 continues testing to determine if the thread priority boost function becomes enabled. Once the thread priority boost function of TPCSM 305 becomes enabled at decision block 515, fetcher 315 or TPCSM 305 chooses or selects a next thread to fetch, as per block 522. TPCSM 305 and instruction fetcher 315 may cooperate to select the next thread for which to fetch instructions. For discussion purposes, assume that the selected instruction is a particular branch instruction in a thread.

The fetcher 315 checks to determine if the next thread for fetch includes a branch instruction that requires a redirect or flush, as per decision block 570. After initialization, the first time through the loop that decision block 570 and blocks 522, 575, 580, 585 and 590 form, there is no redirect or flush. Thus, in that case, fetcher 315 determines a fetch address using branch prediction, as per block 575. Fetcher 315 then accesses the cache memory array 320 to fetch an instruction at the determined fetch address. Process flow continues back to both select next thread block 522 and choose instruction to issue block 525.

Issue unit 330 selects a branch instruction to issue, as per block 525. Issue unit 330 issues the selected branch instruction, as per block 530. The selected branch instruction also executes at this time in BRU 360.

BRU 360 checks the flush information status to determine if a flush is necessary for a particular branch instruction of a thread, as per block 540. Branch execution unit (BRU) 360 sends the flush information to thread priority control state machine (TPCSM) 305, as per block 545. The flush information may include 1) information that indicates whether or not processor 300 requires a flush operation after executing the particular branch instruction in the particular thread, and 2) the thread ID of the particular thread. BRU 360 then distributes the branch prediction correct/incorrect status to fetcher 315, as per block 545.

At substantially the same time that the flush information check of block 540 and the flush information distribution of block 545 occur on the left side of the flowchart, TPCSM 305 performs the functions described in boxes 550, 555, and 560 on the right side of the flowchart. TPCSM 305 checks the flush information that it receives from BRU 360 to determine if it is necessary for processor 300 to perform a flush operation and redirect, as per decision block 550

If the flush information indicates that a flush operation is not necessary for the particular branch instruction, then TPCSM 305 instructs fetcher 315 to schedule a thread without altering the priority of the thread including the particular branch instruction in response to the flush information, as per block 555. In other words, fetcher 315 performs normal thread scheduling and uses current thread priority settings for the thread including the particular branch instruction. However, if the flush information for the particular branch instruction indicates that a flush operation is necessary, such as the case of a branch mispredict, then TPCSM 305 temporarily increases or boosts the priority of the thread including the particular branch instruction, as per block 560. In response to TPCSM 305 increasing the priority of the thread including the particular branch instruction, fetcher 315 schedules this thread for fetch in the next processor cycle rather than waiting until later as would otherwise occur if TPCSM 305 did not boost the priority of the thread. In this manner, in the event of a flush operation by issue logic (not shown) in issue logic 330, the thread including the branch instruction resulting in the flush operation will obtain increased access to memory array 320 over several cycles following the flush event.

The flowchart of FIG. 5 shows a dashed rectangle 562 to indicate that blocks 525, 540, 545, 550, 555 and 560 are separated in time from blocks 525 and 530 of dashed rectangle 523. More specifically, while BRU 360 checks flush information in block 540 and distributes that flush information in block 545, TPCSM 305 checks flush information in blocks 550, 560 and affects the scheduling of the thread including the particular branch instruction in blocks 555, 560. Processor 305 thus conducts blocks 540, 545 in parallel or substantially simultaneously in time with blocks 550, 555 and 560, in one embodiment. The flowchart of FIG. 5 also shows a dashed rectangle 592 around fetcher operational blocks 570, 575, 580, 585 and 590. These fetch operational blocks transpire in approximately the same time domain as the TPCSM operational block 550, 555 and 560 of dashed rectangle 562.

After increasing or boosting thread priority in block 560 or leaving thread priority unchanged in block 555, process flow continues to select next thread block 522. In block 522, TPCSM 305 selects, or the fetcher 315 selects, or TPCSM 305 and fetcher 315 cooperatively select the next thread for which to fetch instructions. In decision block 570, fetcher 315 performs a test to determine if processor 300 should process a redirect in response to a branch misprediction that BRU 360 detected during block 545. If fetcher 315 finds no pending redirect at decision block 570 (i.e. the branch prediction was correct for the particular branch instruction), then fetcher 315 determines the fetch address using branch prediction and sequential next line address prediction techniques. Using this fetch address, fetcher 315 accesses memory array 320, as per block 580. Process flow then continues back to select another thread to fetch for the instruction fetcher block 522, and the instruction flows to issue block 525 at which the process continues. However, if fetcher 315 finds that a redirect is pending (i.e. the branch prediction was incorrect for the particular branch instruction), then a branch redirect occurs. In the event of such a branch redirect, fetcher 315 determines the fetch address for the thread for which block 560 previously boosted thread priority, as per block 585. Using this fetch address, fetcher 315 accesses memory array 320, as per block 590. Process flow then continues back to select another thread to fetch for the instruction fetcher 315 at block 522, and the fetched instruction flows to block 525 as the process continues.

There are a number of different ways to modify thread priority consistent with the teachings herein. For example, processor 300 may boost or increase the actual priority of the thread including the particular branch instruction. Alternatively, TPCSM 305 processor 300 may override an allocation of fetch cycles with respect to a specific number of cycles after the flush operation that the fetcher and thread priority controller allocate (i.e. override a few cycles). This override fetch cycle allocation action will temporarily boost the priority of the particular thread exhibiting the flush event and, for this particular thread, allow the issue queue to fill with instructions. In this manner, the override fetch cycle allocation approach provides an effective thread priority increase that supplies ready instructions to issue logic to enable the issue logic to issue more instructions for the particular thread and to extract more instruction level parallelism therefrom. In yet another approach, the fetcher and thread priority controller may effectively modify thread priority by changing the ordering of thread assignments, namely by modifying the order in which the processor 300 services the threads. This thread assignment ordering approach allocates an increased number of cycles to the particular thread involved in the flush event, without unduly disadvantaging other threads over a predetermined time window. In one alternative embodiment, it is possible that any branch instruction requiring a thread priority boost may receive such a boost.

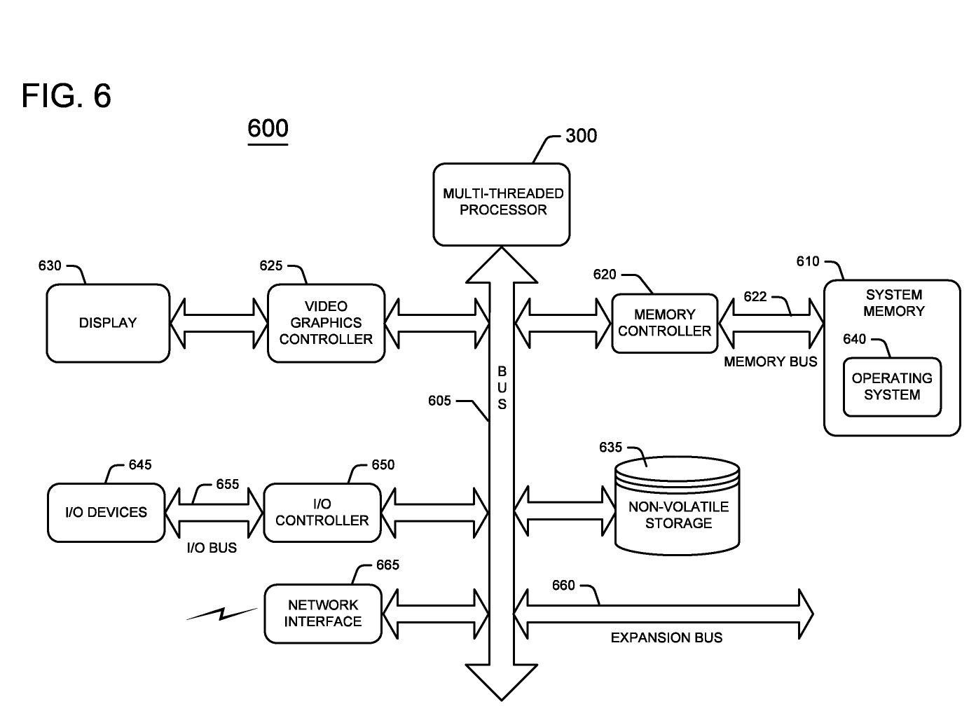

FIG. 6 shows an information handling system (IHS) 600 that employs multi-threaded processor 300. An IHS is a system that processes, transfers, communicates, modifies, stores or otherwise handles information in digital form, analog form or other form. IHS 600 includes a bus 605 that couples processor 300 to system memory 610 via a memory controller 620 and memory bus 622. A video graphics controller 625 couples display 630 to bus 605. Nonvolatile storage 635, such as a hard disk drive, CD drive, DVD drive, or other nonvolatile storage couples to bus 605 to provide IHS 600 with permanent storage of information. An operating system 640 loads in memory 610 to govern the operation of IHS 600. I/O devices 645, such as a keyboard and a mouse pointing device, couple to bus 605 via I/O controller 650 and I/O bus 655. One or more expansion busses 660, such as USB, IEEE 1394 bus, ATA, SATA, PCI, PCIE and other busses, couple to bus 605 to facilitate the connection of peripherals and devices to IHS 600. A network adapter 665 couples to bus 605 to enable IHS 600 to connect by wire or wirelessly to a network and other information handling systems. While FIG. 6 shows one IHS that employs processor 300, the IHS may take many forms. For example, IHS 600 may take the form of a desktop, server, portable, laptop, notebook, or other form factor computer or data processing system. IHS 600 may take other form factors such as a gaming device, a personal digital assistant (PDA), a portable telephone device, a communication device or other devices that include a processor and memory.

Modifications and alternative embodiments of this invention will be apparent to those skilled in the art in view of this description of the invention. Accordingly, this description teaches those skilled in the art the manner of carrying out the invention and is intended to be construed as illustrative only. The forms of the invention shown and described constitute the present embodiments. Persons skilled in the art may make various changes in the shape, size and arrangement of parts. For example, persons skilled in the art may substitute equivalent elements for the elements illustrated and described here. Moreover, persons skilled in the art after having the benefit of this description of the invention may use certain features of the invention independently of the use of other features, without departing from the scope of the invention.

What is claimed is:

1. A method of operating a multi-threaded processor, the method comprising:
storing, by a memory array, a plurality of instruction threads;
fetching, by a fetcher, a particular instruction thread from the memory array, the particular instruction thread including a particular branch instruction, the fetcher communicating with a thread priority controller;
predicting, by a branch predictor, an outcome of the particular branch instruction of the particular instruction thread, thus providing a branch prediction;
issuing, by an issue unit, the particular branch instruction of the particular instruction thread to a branch execution unit;
speculatively executing, by the branch execution unit, the particular branch instruction of the particular instruction thread in response to the branch prediction;
sending, by the branch execution unit, flush information to the thread priority controller, the flush information indicating the correctness or incorrectness of the branch prediction for the particular branch instruction of the particular thread; and
modifying, by the thread priority controller, a priority of the particular instruction thread in response to the flush information indicating that the particular branch instruction was incorrectly predicted.

2. The method of claim 1, wherein the modifying step comprises increasing, by the thread priority controller, the priority of the particular instruction thread in response to the flush information indicating that the particular branch instruction was incorrectly predicted.

3. The method of claim 1, wherein the modifying step comprises changing, by the thread priority controller, a thread slot assignment of the particular branch instruction of the particular thread.

4. The method of claim 1, wherein the modifying step comprises overriding, by the thread priority controller, a fetch cycle allocation to effectively increase the priority of the particular thread.

5. The method of claim 4, wherein the overriding step comprises changing. by the thread priority controller, the fetch cycle allocation of the particular thread to effectively increase a number of fetch cycles allocated to the particular thread.

6. The method of claim 1, wherein the flush information includes a thread ID for the particular thread including the particular branch instruction.

7. The method of claim 1, further comprising leaving unaltered, by the thread priority controller, the priority of the particular thread that includes the particular branch instruction, if the flush information corresponding to the particular branch instruction indicates that a processor flush operation is unnecessary for the particular branch instruction.

8. A processor comprising:
a memory array that stores instruction threads that include branch instructions;
a fetcher, coupled to the memory array, that fetches a particular instruction thread including a particular branch instruction from the memory array;
a branch predictor, coupled to the fetcher, that predicts an outcome of the particular branch instruction, thus providing a branch prediction for the particular branch instruction;
a branch execution unit, coupled to the branch predictor, that executes branch instructions and provides flush information related to the branch instructions that it executes;
an issue unit, coupled to the memory array and the branch execution unit, that issues the particular branch instruction of the particular thread to the branch execution unit for execution, and
a thread priority controller, coupled to branch execution unit and the memory array, to receive the flush information from the branch execution unit, wherein the thread priority controller modifies a priority of the particular instruction thread in response to the flush information indicating that the particular branch instruction of the particular instruction thread was incorrectly predicted.

9. The processor of claim 8, wherein the thread priority controller is configured to modify the priority of the particular instruction thread in response to the flush information indicating that the particular branch instruction was incorrectly predicted.

10. The processor of claim 8, wherein the thread priority controller is configured to change a thread slot assignment of the particular branch instruction of the particular thread.

11. The processor of claim 8, wherein the thread priority controller is configured to override a fetch cycle allocation to effectively increase the priority of the particular thread.

12. The processor of claim 11, wherein the thread priority controller is configured to change the fetch cycle allocation of the particular thread to effectively increase a number of fetch cycles allocated to the particular thread.

13. The processor of claim 8, wherein the flush information includes a thread ID for the particular thread including the particular branch instruction.

14. The processor of claim 8, further comprising leaving unaltered, by the thread priority controller, the priority of the particular thread that includes the particular branch instruction, if the flush information corresponding to the particular branch instruction indicates that a processor flush operation is unnecessary for the particular branch instruction.

15. An information handling system (IHS) comprising:
a system memory;
a processor coupled to the system memory, the processor including:
a memory array that stores instruction threads that include branch instructions;
a fetcher, coupled to the memory array, that fetches a particular instruction thread including a particular branch instruction from the memory array;
a branch predictor, coupled to the fetcher, that predicts an outcome of the particular branch instruction, thus providing a branch prediction for the particular branch instruction;
a branch execution unit, coupled to the branch predictor, that executes branch instructions and provides flush information related to the branch instructions that it executes;
an issue unit, coupled to the memory array and the branch execution unit, that issues the particular branch instruction of the particular thread to the branch execution unit for execution, and
a thread priority controller, coupled to branch execution unit and the memory array, to receive the flush information from the branch execution unit, wherein the thread priority controller modifies a priority of the particular instruction thread in response to the flush information indicating that the particular branch instruction of the particular instruction thread was incorrectly predicted.

16. The IHS of claim 15, wherein the thread priority controller is configured to modify the priority of the particular instruction thread in response to the flush information indicating that the particular branch instruction was incorrectly predicted.

17. The IHS of claim 15, wherein the thread priority controller is configured to change a thread slot assignment of the particular branch instruction of the particular thread.

18. The IHS of claim 15, wherein the thread priority controller is configured to override a fetch cycle allocation to effectively increase the priority of the particular thread.

19. The IHS of claim 18, wherein the thread priority controller is configured to change the fetch cycle allocation of the particular thread to effectively increase a number of fetch cycles allocated to the particular thread.

20. The IHS of claim 15, wherein the flush information includes a thread ID for the particular thread including the particular branch instruction.
